(19) United States
(12) Patent Application Publication
(10) Pub. No.: US 2015/0192149 A1
(43) Pub. Date: Jul. 9, 2015

(54) APPARATUS AND METHOD FOR HYDRAULIC SYSTEMS

(71) Applicant: CATERPILLAR INC., Peoria, IL (US)

(72) Inventors: PENGFEI MA, NAPERVILLE, IL (US); JIAO ZHANG, NAPERVILLE, IL (US); ALEKSANDAR EGELJA, NAPERVILLE, IL (US); MICHAEL SCHWAB, CREST HILL, IL (US)

(73) Assignee: CATERPILLAR INC., Peoria, IL (US)

(21) Appl. No.: 14/147,097

(22) Filed: Jan. 3, 2014

(51) Int. Cl. F15B 7/08; F15B 1/027

(52) U.S. Cl. CPC F15B 7/08; F15B 1/0275

(57) ABSTRACT

A hydraulic system and a method are disclosed. The hydraulic system includes a first pump having an outlet that is fluidly coupled to a first actuator via a first conduit, a second pump having an outlet that is fluidly coupled to a second actuator via a second conduit, a flow control module, and a controller operatively coupled to the flow control module, the controller being configured to operate the flow control module in a first mode, such that the flow control module effects fluid communication between the auxiliary pump and the first actuator and blocks fluid communication between the auxiliary pump and the first actuator, and operate the flow control module in a second mode, such that the flow control module effects fluid communication between the auxiliary pump and the second actuator and blocks fluid communication between the auxiliary pump and the second actuator.

### TECHNICAL FIELD

This patent disclosure relates generally to hydraulic systems and, more particularly, to a hydraulic system for selectively driving two or more hydraulic actuators.

### BACKGROUND

Hydraulic systems are known for converting fluid energy, for example, fluid pressure, into mechanical power. Fluid power may be transferred from one or more hydraulic pumps through fluid conduits to one or more hydraulic actuators. Hydraulic actuators may include hydraulic motors that convert fluid power into shaft rotational power, hydraulic cylinders that convert fluid power into translational motion, or other hydraulic actuators known in the art.

In an open-loop hydraulic system, fluid discharged from an actuator is directed to a low-pressure reservoir, from which the pump draws fluid. In a closed-loop hydraulic system, a pump is coupled to a hydraulic motor through a motor supply conduit and a pump return conduit, such that all of the hydraulic fluid is not returned to a low-pressure reservoir upon each pass through the closed-loop. Instead, fluid discharged from an actuator in a closed-loop system is directed back to the pump for immediate recirculation.

Japanese Publication No. 2013-036495 (hereinafter “the '495 publication”), entitled “Hydraulic Circuit for Construction Machinery,” purports to describe a hydraulic system where individual pumps in a three pump system may supply hydraulic fluid to a work actuator via a main circuit, or deliver hydraulic fluid to an accumulator circuit as a source of pilot hydraulic pressure. However, the hydraulic system of the '495 publication does not provide flexibility for directing the output of an individual pump to more than one work actuator.

Accordingly, there is a need for an improved hydraulic system to address the problems described above and/or problems posed by other conventional approaches.

### SUMMARY

In one aspect, the disclosure describes a hydraulic system. The hydraulic system includes a first pump having an outlet that is fluidly coupled to a first actuator via a first conduit, a second pump having an outlet that is fluidly coupled to a second actuator via a second conduit, a flow control module, and a controller operatively coupled to the flow control module. The flow control module is fluidly coupled to an outlet of an auxiliary pump via a third conduit, the first conduit via a fourth conduit, and the second conduit via a fifth conduit. The controller is configured to operate the flow control module in a first mode, such that the flow control module effects fluid communication between the auxiliary pump and the first actuator via the fourth conduit and blocks fluid communication between the auxiliary pump and the second actuator via the fifth conduit, and operate the flow control module in a second mode, such that the flow control module effects fluid communication between the auxiliary pump and the second actuator via the fifth conduit and blocks fluid communication between the auxiliary pump and the first actuator via the fourth conduit.

In yet another aspect, the disclosure describes a method of controlling a hydraulic system. The hydraulic system includes a first pump having an outlet that is fluidly coupled to a first actuator via a first conduit, a second pump having an outlet that is fluidly coupled to a second actuator via a second conduit, and a flow control module fluidly coupled to an outlet of an auxiliary pump via a third conduit, the first conduit via a fourth conduit, and the second conduit via a fifth conduit. The method comprising operating the flow control module in a first mode, such that the flow control module effects fluid communication between the auxiliary pump and the first actuator via the fourth conduit and blocks fluid communication between the auxiliary pump and the second actuator via the fifth conduit, and operating the flow control module in a second mode, such that the flow control module effects fluid communication between the auxiliary pump and the second actuator via the fifth conduit and blocks fluid communication between the auxiliary pump and the first actuator via the fourth conduit.

### BRIEF DESCRIPTION OF THE DRAWINGS

FIG. 1 illustrates an exemplary machine, according to an aspect of the disclosure.

FIG. 2 shows a schematic view of a linear hydraulic cylinder, according to an aspect of the disclosure.

FIG. 3 shows a schematic view of a hydraulic system, according to an aspect of the disclosure.

FIG. 4 shows a schematic view of a flow control module, according to an aspect of the disclosure.

FIG. 5 shows a schematic of a control valve assembly, according to an aspect of the disclosure.

### DETAILED DESCRIPTION

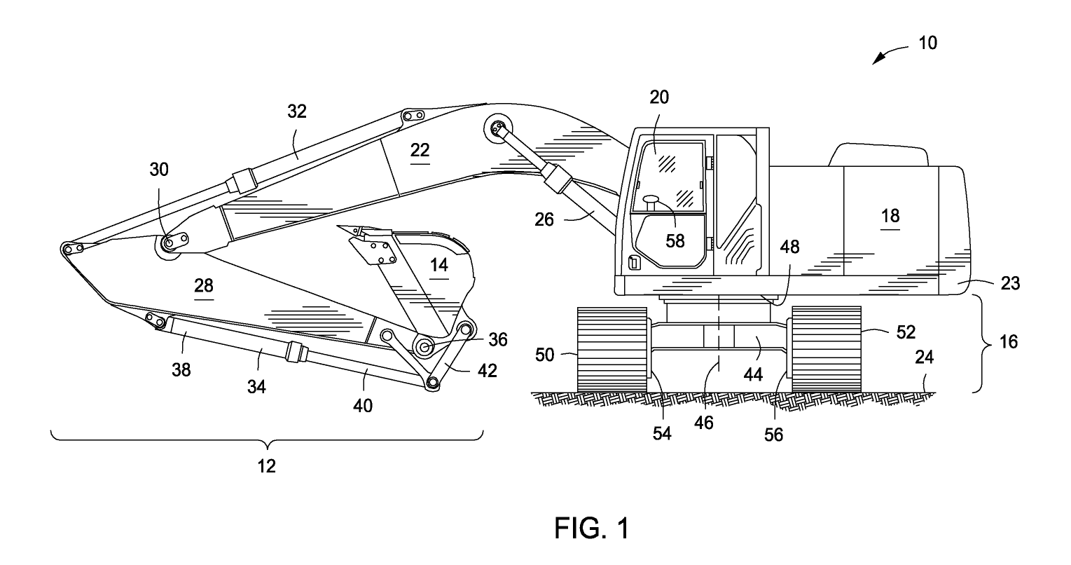

FIG. 1 illustrates an exemplary machine 10 having various systems and components that cooperate to accomplish a task. The machine 10 may embody a fixed or mobile machine that performs some type of operation associated with an industry such as mining, construction, farming, transportation, or another industry known in the art. For example, the machine 10 may be an earth moving machine such as a shovel or an excavator (shown in FIG. 1), a dozer, a loader, a backhoe, a motor grader, a dump truck, or another earth moving machine. The machine 10 may include an implement system 12 configured to move a work tool 14, a drive system 16 for propelling the machine 10, a power source 18 or other prime mover that provides power to the implement system 12 and the drive system 16, and an operator station 20 that may include control interfaces for manual control of the implement system 12, the drive system 16, and/or the power source 18.

The implement system 12 may include a linkage structure coupled to hydraulic actuators, which may include linear or rotary actuators, to move the work tool 14. For example, the implement system 12 may include a boom 22 that is pivotally coupled to a body 23 of the machine 10 about a first horizontal axis (not shown), with respect to the work surface 24, and actuated by one or more double-acting, boom hydraulic cylinders 26 (only one shown in FIG. 1). The implement system 12 may also include a stick 28 that is pivotally coupled to the boom 22 about a second horizontal axis 30, with respect to the work surface 24, and actuated by a double-acting, stick hydraulic cylinder 32.

The implement system 12 may further include a double-acting, tool hydraulic cylinder 34 that is operatively coupled between the stick 28 and the work tool 14 to pivot the work tool 14 about a third horizontal axis 36. In the non-limiting aspect illustrated in FIG. 1, a head-end 38 of the tool hydraulic cylinder 34 is connected to a portion of the stick 28, and an opposing rod-end 40 of the tool hydraulic cylinder 34 is connected to the work tool 14 by way of a power link 42. The body 23 may be connected to an undercarriage 44 to swing about a vertical axis 46 by a hydraulic swing motor 48.

Numerous different work tools 14 may be attached to a single machine 10 and controlled by an operator. The work tool 14 may include any device used to perform a particular task such as, for example, a bucket (shown in FIG. 1), a fork arrangement, a blade, a shovel, a ripper, a dump bed, a broom, a snow blower, a propelling device, a cutting device, a grasping device, or any other task-performing device known in the art. Although the aspect illustrated in FIG. 1 shows the work tool 14 configured to pivot in the vertical direction relative to the body 23 and to swing in the horizontal direction about the pivot axis 46, it will be appreciated that the work tool 14 may alternatively or additionally rotate relative to the stick 28, slide, open and close, or move in any other manner known in the art.

The drive system 16 may include one or more traction devices powered to propel the machine 10. As illustrated in FIG. 1, the drive system 16 may include a left track 50 located on one side of the machine 10, and a right track 52 located on an opposing side of the machine 10. The left track 50 may be driven by a left travel motor 54, and the right track 52 may be driven by a right travel motor 56. It is contemplated that the drive system 16 could alternatively include traction devices other than tracks, such as wheels, belts, or other known fraction devices. The machine 10 may be steered by generating a speed and/or rotational direction difference between the left travel motor 54 and the right travel motor 56, while straight travel may be effected by generating substantially equal output speeds and rotational directions of the left travel motor 54 and the right travel motor 56.

The power source 18 may include a combustion engine such as, for example, a reciprocating compression ignition engine, a reciprocating spark ignition engine, a combustion turbine, or another type of combustion engine known in the art. It is contemplated that the power source 18 may alternatively include a non-combustion source of power such as a fuel cell, a power storage device, or another power source known in the art. The power source 18 may produce a mechanical or electrical power output that may then be converted to hydraulic power for moving the linear or rotary actuators of the implement system 12.

The operator station 20 may include devices that receive input from an operator indicative of desired maneuvering. Specifically, the operator station 20 may include one or more operator interface devices 58, for example a joystick (shown in FIG. 1), a steering wheel, or a pedal, that are located near an operator seat (not shown). Operator interface devices may initiate movement of the machine 10, for example travel and/or tool movement, by producing displacement signals that are indicative of desired machine 10 maneuvering. As an operator moves interface device 58, the operator may affect a corresponding machine 10 movement in a desired direction, with a desired speed, and/or with a desired force.

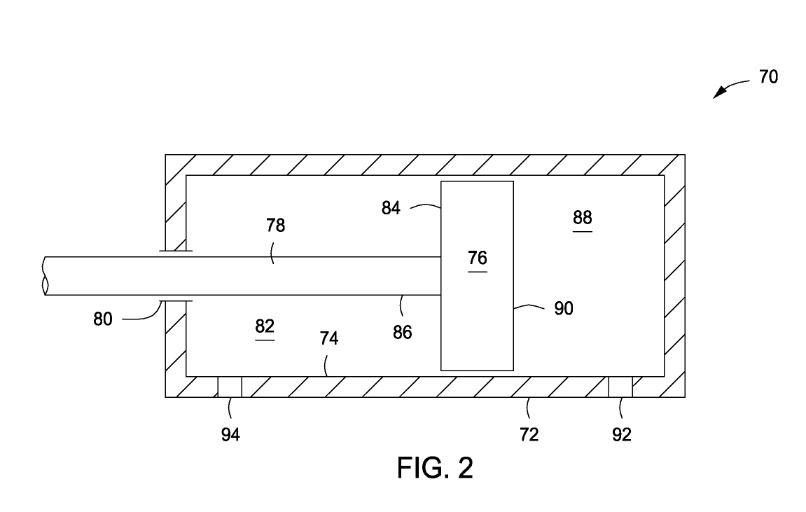

FIG. 2 shows a schematic view of a linear hydraulic cylinder 70, according to an aspect of the disclosure. The linear hydraulic cylinder 70 may include a tube 72 defining a cylinder bore 74 therein, and a piston assembly 76 disposed within the cylinder bore 74. A rod 78 is coupled to the piston assembly 76 and extends through the tube 72 at a seal 80. A rod-end chamber 82 is defined by a first face 84 of the piston, the cylinder bore 74, and a surface 86 of the rod 78. A head-end chamber 88 is defined by a second face 90 of the piston and the cylinder bore 74.

The head-end chamber 88 and the rod-end chamber 82 of the linear hydraulic actuator 70 may be selectively supplied with pressurized fluid or drained of fluid via the head-end port 92 and the rod-end port 94, respectively, to cause piston assembly 76 to translate within tube 72, thereby changing the effective length of the actuator to move work tool 14, for example. A flow rate of fluid into and out of the head-end chamber 88 and the rod-end chamber 82 may relate to a translational velocity of the actuator, while a pressure differential between the head-end chamber 88 and the rod-end chamber 82 may relate to a force imparted by the actuator on the work tool 14. It will be appreciated that any of the boom hydraulic cylinders 26, the stick hydraulic cylinder 32, or the tool hydraulic cylinder 34, shown in FIG. 1, may embody structural features of the linear hydraulic actuator 70 illustrated in FIG. 2.

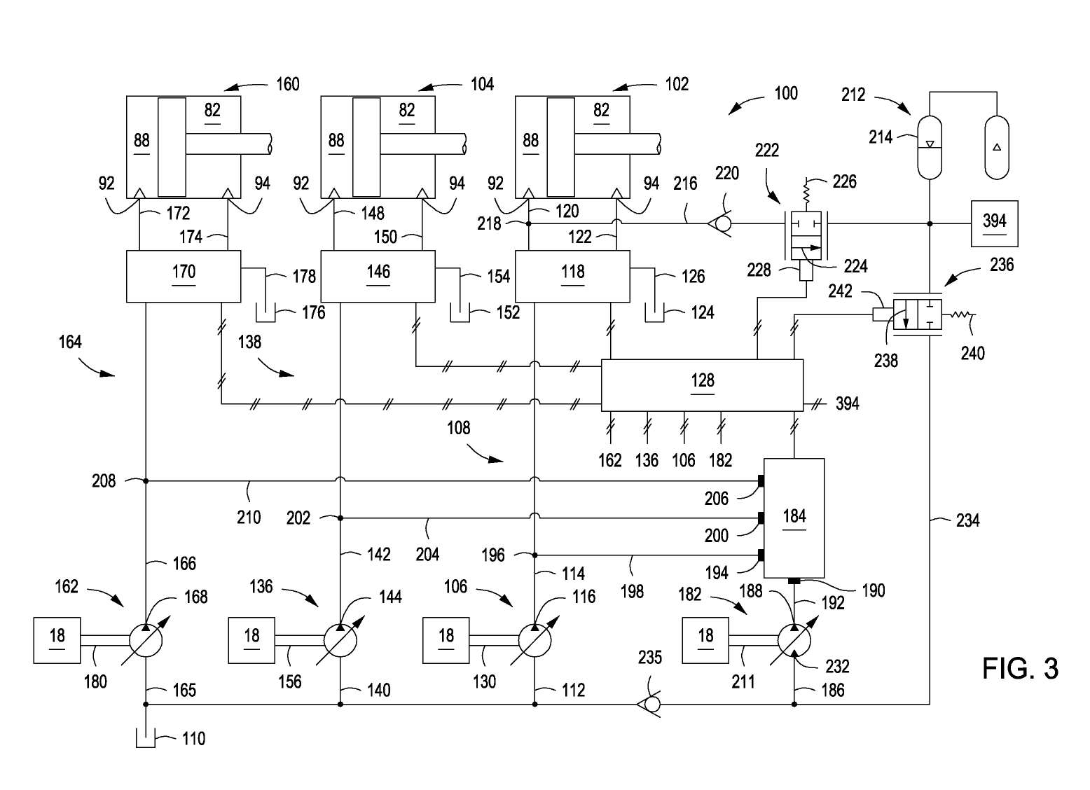

FIG. 3 shows a hydraulic system 100, according to an aspect of the disclosure. The hydraulic system 100 includes a first actuator 102 and a second actuator 104. The first actuator 102 may embody the structure of the linear hydraulic actuator 70 illustrated in FIG. 2. Thus, the first actuator 102 may have a head-end chamber 88, a rod-end chamber 82, a head-end port 92, and a rod-end port 94. It will be appreciated that the first actuator 102 may be a boom hydraulic cylinder 26, a stick hydraulic cylinder 32, or a tool hydraulic cylinder 34 of the machine 10, as shown in FIG. 1, or serve any other hydraulic cylinder function known in the art.

The first actuator 102 is fluidly coupled to a first pump 106 in a first open-loop circuit 108. The first pump 106 may draw hydraulic fluid from a reservoir 110 via a conduit 112 and discharge the hydraulic fluid to a conduit 114 via a first pump outlet 116. The first open-loop circuit 108 includes a control valve assembly 118 in fluid communication with the conduit 114. The control valve assembly 118 is also in fluid communication with the head-end port 92 and the rod-end port 94 of the first actuator 102 via the conduit 120 and the conduit 122, respectively. According to an aspect of the disclosure, the reservoir 110 is in fluid communication with an ambient environment of the machine 10.

In a first configuration, the control valve assembly 118 effects fluid communication between the first pump 106 and the head-end chamber 88 of the first actuator 102 via the conduit 114 and the conduit 120, and effects fluid communication between the rod-end chamber 82 of the first actuator 102 and the reservoir 124 via the conduit 122 and the conduit 126. In a second configuration, the control valve assembly 118 effects fluid communication between the first pump 106 and the rod-end chamber 82 of the first actuator 102 via the conduit 114 and the conduit 122, and effects fluid communication between the head-end chamber 88 of the first actuator 102 and the reservoir 124 via the conduit 120 and the conduit 126. In a third configuration, the control valve assembly blocks all fluid communication between the first actuator 102 and either the first pump 106 or the reservoir 124 via the control valve assembly 118.

The first configuration and the second configuration of the control valve assembly 118 may not effect any fluid communication between the head-end chamber 88 and the rod-end chamber 82 of the first actuator 102 via the control valve assembly 118. Alternatively, the control valve assembly 118 may effect at least some fluid communication between the head-end chamber 88 and the rod-end chamber 82 of the first actuator 102 when the control valve assembly 118 is in the first configuration, the second configuration, or both.

The control valve assembly 118 may be operatively coupled to a controller 128, such that the controller 128 may cause the control valve assembly 118 to assume any of the first configuration, the second configuration, the third configuration, or other possible configurations of the control valve assembly 118. According to an aspect of the disclosure, control valve assembly 118 toggles between the first configuration, the second configuration, and the third configuration in response to a control signal from the controller 128. According to another aspect of the disclosure, the control valve assembly throttles a degree of fluid communication in the first configuration and the second configuration proportional to a control signal from the controller 128.

The reservoir 124 may be the same as the reservoir 110, or the reservoir 124 may be distinct from the reservoir 110. Further, it will be appreciated that the reservoir 124 may be distinct from the reservoir 110 but still be in fluid communication with the reservoir 110 via a flow passage, a pump, or combinations thereof.

The first pump 106 may have variable displacement, which is controlled via controller 128 to draw fluid from the reservoir 110 and discharge the fluid at a specified elevated pressure to the conduit 114. The first pump 106 may include a stroke-adjusting mechanism, for example a swashplate, a position of which is hydro-mechanically adjusted based on, among other things, a desired speed of the actuators, to thereby vary an output (e.g., a discharge rate) of the first pump 106. It is contemplated that first pump 106 may be coupled to the power source 18 in tandem (e.g., via the same shaft) or in parallel (e.g., via a gear train) with other pumps of the machine 10, as desired. Further, the displacement of the first pump 106 may be adjusted from a zero displacement position at which substantially no fluid is discharged from first pump 106, to a maximum displacement position at which fluid is discharged from first pump 106 at a maximum rate into the conduit 114 of the first open-loop circuit 108.

The first pump 106 may be directly or indirectly coupled to the power source 18 via a shaft 130. Indirect coupling between the shaft 130 of the first pump 106 and the power source 18 may include a torque converter, a gear box, an electrical circuit, or other coupling method known in the art.

Referring still to FIG. 3, the second actuator 104 may embody the structure of the linear hydraulic actuator 70 illustrated in FIG. 2. Thus, the second actuator 104 may have a head-end chamber 88, a rod-end chamber 82, a head-end port 92, and a rod-end port 94. It will be appreciated that the second actuator 104 may be a boom hydraulic cylinder 26, a stick hydraulic cylinder 32, or a tool hydraulic cylinder 34 of the machine 10, as shown in FIG. 1, or serve any other hydraulic cylinder function known in the art.

The second actuator 104 is fluidly coupled to a second pump 136 in a second open-loop circuit 138. The second pump 136 may draw hydraulic fluid from the reservoir 110 via a conduit 140 and discharge the hydraulic fluid to a conduit 142 via a second pump outlet 144. The second open-loop circuit 138 includes a control valve assembly 146 in fluid communication with the conduit 142. The control valve assembly 146 is also in fluid communication with the head-end port 92 and the rod-end port 94 of the second actuator 104 via the conduit 148 and the conduit 150, respectively.

In a first configuration, the control valve assembly 146 effects fluid communication between the second pump 136 and the head-end chamber 88 of the second actuator 104 via the conduit 142 and the conduit 148, and effects fluid communication between the rod-end chamber 82 of the second actuator 104 and the reservoir 152 via the conduit 150 and the conduit 154. In a second configuration, the control valve assembly 146 effects fluid communication between the second pump 136 and the rod-end chamber 82 of the second actuator 104 via the conduit 142 and the conduit 150, and effects fluid communication between the head-end chamber 88 of the second actuator 104 and the reservoir 152 via the conduit 148 and the conduit 154. In a third configuration, the control valve assembly blocks all fluid communication between the second actuator 104 and either the second pump 136 or the reservoir 152 via the control valve assembly 146.

The first configuration and the second configuration of the control valve assembly 146 may not effect any fluid communication between the head-end chamber 88 and the rod-end chamber 82 of the second actuator 104 via the control valve assembly 146. Alternatively, the control valve assembly 146 may effect at least some fluid communication between the head-end chamber 88 and the rod-end chamber 82 of the second actuator 104 when the control valve assembly 146 is in the first configuration, the second configuration, or both.

The control valve assembly 146 may be operatively coupled to the controller 128, such that the controller 128 may cause the control valve assembly 146 to assume any of the first configuration, the second configuration, the third configuration, or other possible configurations of the control valve assembly 146. According to an aspect of the disclosure, control valve assembly 146 toggles between the first configuration, the second configuration, and the third configuration in response to a control signal from the controller 128. According to another aspect of the disclosure, the control valve assembly throttles a degree of fluid communication in the first configuration and the second configuration proportional to a control signal from the controller 128.

The reservoir 152 may be the same as the reservoir 110 or the reservoir 124, or the reservoir 152 may be distinct from the reservoir 110, the reservoir 124, or both. Further, it will be appreciated that the reservoir 152 may be distinct from the reservoir 110 but still be in fluid communication with the reservoir 110 via a flow passage, a pump, or combinations thereof.

The second pump 136 may have variable displacement, which is controlled via the controller 128 to draw fluid from the reservoir 110 and discharge the fluid at a specified elevated pressure to the conduit 142. The second pump 136 may include a stroke-adjusting mechanism, for example a swashplate, a position of which is hydro-mechanically adjusted based on, among other things, a desired speed of the actuators, to thereby vary an output (e.g., a discharge rate) of the second pump 136. It is contemplated that second pump 136 may be coupled to the power source 18 in tandem (e.g., via the same shaft) or in parallel (e.g., via a gear train) with other pumps of the machine 10, as desired. Further, the displacement of the second pump 136 may be adjusted from a zero displacement position at which substantially no fluid is discharged from second pump 136, to a maximum displacement position at which fluid is discharged from second pump 136 at a maximum rate into the conduit 142 of the second open-loop circuit 138.

The second pump 136 may be directly or indirectly coupled to the power source 18 via a shaft 156. Indirect coupling between the shaft 156 of the second pump 136 and the power source 18 may include a torque converter, a gear box, an electrical circuit, or other coupling method known in the art.

Referring still to FIG. 3, the hydraulic system 100 may further include a third actuator 160, which may embody the structure of the linear hydraulic actuator 70 illustrated in FIG. 2. Thus, the third actuator 160 may have a head-end chamber 88, a rod-end chamber 82, a head-end port 92, and a rod-end port 94. It will be appreciated that the third actuator 160 may be a boom hydraulic cylinder 26, a stick hydraulic cylinder 32, or a tool hydraulic cylinder 34 of the machine 10, as shown in FIG. 1, or serve any other hydraulic cylinder function known in the art.

The third actuator 160 is fluidly coupled to a third pump 162 in a third open-loop circuit 164. The third pump 162 may draw hydraulic fluid from the reservoir 110 via a conduit 165 and discharge the hydraulic fluid to a conduit 166 via a third pump outlet 168. The third open-loop circuit 164 includes a control valve assembly 170 in fluid communication with the conduit 166. The control valve assembly 170 is also in fluid communication with the head-end port 92 and the rod-end port 94 of the third actuator 160 via the conduit 172 and the conduit 174, respectively.

In a first configuration, the control valve assembly 170 effects fluid communication between the third pump 162 and the head-end chamber 88 of the third actuator 160 via the conduit 166 and the conduit 172, and effects fluid communication between the rod-end chamber 82 of the third actuator 160 and the reservoir 176 via the conduit 174 and the conduit 178. In a second configuration, the control valve assembly 170 effects fluid communication between the third pump 162 and the rod-end chamber 82 of the third actuator 160 via the conduit 166 and the conduit 174, and effects fluid communication between the head-end chamber 88 of the third actuator 160 and the reservoir 176 via the conduit 172 and the conduit 178. In a third configuration, the control valve assembly blocks all fluid communication between the third actuator 160 and either the third pump 162 or the reservoir 176 via the control valve assembly 170.

The first configuration and the second configuration of the control valve assembly 170 may not effect any fluid communication between the head-end chamber 88 and the rod-end chamber 82 of the third actuator 160 via the control valve assembly 170. Alternatively, the control valve assembly 170 may effect at least some fluid communication between the head-end chamber 88 and the rod-end chamber 82 of the third actuator 160 when the control valve assembly 170 is in the first configuration, the second configuration, or both.

The control valve assembly 170 may be operatively coupled to the controller 128, such that the controller 128 may cause the control valve assembly 170 to assume any of the first configuration, the second configuration, the third configuration, or other possible configurations of the control valve assembly 170. According to an aspect of the disclosure, control valve assembly 170 toggles between the first configuration, the second configuration and the third configuration in response to a control signal from the controller 128. According to another aspect of the disclosure, the control valve assembly throttles a degree of fluid communication in the first configuration and the second configuration proportionally to a control signal from the controller 128.

The reservoir 176 may be the same as the reservoir 110, the reservoir 124, or the reservoir 152. Alternatively, the reservoir 176 may be distinct from the reservoir 110, the reservoir 124, the reservoir 152, or combinations thereof. Further, it will be appreciated that the reservoir 176 may be distinct from the reservoir 110 but still be in fluid communication with the reservoir 110 via a flow passage, a pump, or combinations thereof.

The third pump 162 may have variable displacement, which is controlled via the controller 128 to draw fluid from the reservoir 110 and discharge the fluid at a specified elevated pressure to the conduit 166. The third pump 162 may include a stroke-adjusting mechanism, for example a swashplate, a position of which is hydro-mechanically adjusted based on, among other things, a desired speed of the actuators, to thereby vary an output (e.g., a discharge rate) of the third pump 162. It is contemplated that third pump 162 may be coupled to the power source 18 in tandem (e.g., via the same shaft) or in parallel (e.g., via a gear train) with other pumps of the machine 10, as desired. Further, the displacement of the third pump 162 may be adjusted from a zero displacement position at which substantially no fluid is discharged from third pump 162, to a maximum displacement position at which fluid is discharged from third pump 162 at a maximum rate into the conduit 166 of the third open-loop circuit 164.

The third pump 162 may be directly or indirectly coupled to the power source 18 via a shaft 180. Indirect coupling between the shaft 180 of the third pump 162 and the power source 18 may include a torque converter, a gear box, an electrical circuit, or other coupling method known in the art.

Although the first actuator 102, the second actuator 104, and the third actuator 160 are shown as linear hydraulic cylinders in FIG. 3, it will be appreciated that the first actuator 102, the second actuator 104, and the third actuator 160 could also be rotary hydraulic actuators, or any other type of hydraulic actuator known in the art.

As shown in FIG. 3, the hydraulic system 100 further includes an auxiliary pump 182 and a flow control module 184. The auxiliary pump 182 may draw hydraulic fluid from the reservoir 110 via conduit 186 and discharge the hydraulic fluid at a higher pressure via an auxiliary pump outlet 188. The auxiliary pump outlet 188 is fluidly coupled to a first port 190 of the flow control module 184 via a conduit 192.

A second port 194 of the flow control module 184 is fluidly coupled to the conduit 114 at a node 196 via a conduit 198, and a third port 200 of the flow control module 184 is fluidly coupled to the conduit 142 at a node 202 via a conduit 204. A fourth port 206 of the flow control module 184 may be fluidly coupled to the conduit 166 at the node 208 via a conduit 210.

As summarized in Table 1, different operating modes of the flow control module 184 may effect different states of fluid communication between the first port 190, the second port 194, the third port 200, and the fourth port 206 of the flow control module 184. For example, a first operating mode of the flow control module 184 blocks fluid communication between the first port 190 and any of the second port 194, the third port 200, or the fourth port 206, whereas a second operating mode of the flow control module 184 effects fluid communication between the first port 190 and the second port 194 while blocking fluid communication between the first port 190 and either the third port 200 or the fourth port 206.

Thus, with reference to FIG. 3 and Table 1, the first operating mode of the flow control module 184 may isolate the auxiliary pump 182 from fluid communication with any of the first actuator 102, the second actuator 104, and the third actuator 160 via the flow control module. Likewise, the second operating mode of the flow control module 184 may effect fluid communication between the auxiliary pump 182 and the first actuator 102 via the flow control module 184, while blocking fluid communication between the auxiliary pump 182 and either the second actuator 104 or the third actuator 160 via the flow control module 184.

TABLE 1
Operating Modes for the Flow Control Module 184

| | fluid communication^{†} between | | |
|---|---|---|---|
| | the first port | the first port | the first port |
| | 190 and the | 190 and the | 190 and the |
| Mode | second port 194 | third port 200 | fourth port 206 |
| 1 | 0 | 0 | 0 |
| 2 | 1 | 0 | 0 |
| 3 | 0 | 1 | 0 |
| 4 | 0 | 0 | 1 |
| 5 | 1 | 1 | 0 |
| 6 | 0 | 1 | 1 |
| 7 | 1 | 0 | 1 |
| 8 | 1 | 1 | 1 |

^{†}“0” indicates fluid communication is blocked and “1” indicates fluid communication is effected

According to an aspect of the disclosure, the fifth operating mode of the flow control module 184 from Table 1 effects fluid communication between second port 194 and the third port 200, as well as effecting fluid communication between the first port 190 and each of the second port 194 and the third port 200. In turn, the fifth operating mode of the flow control module 184 may effect fluid communication between the auxiliary pump 182 and the first actuator 102 and the second actuator 104 via the flow control module 184, as well as effect fluid communication between the second pump 136 and the first actuator 102 or the first pump 106 and the second actuator 104 via the flow control module 184.

However, it will be appreciated that according to another aspect of the disclosure, the fifth operating mode of the flow control module 184 from Table 1 does not effect fluid communication between the second port 194 and the third port 200. For example, according to the fifth operating mode of the flow control module 184 from Table 1, it will be appreciated that check valves, or the like, within the flow control module 184 may prevent fluid communication between the second port 194 and the third port 200 via the flow control module 184. Similarly, the sixth operating mode of the flow control module 184 may or may not effect fluid communication between the third port 200 and the fourth port 206, and the seventh operating mode of the flow control module 184 may or may not effect fluid communication between the second port 194 and the fourth port 206.

Accordingly, depending on the operating mode of the flow control module 184, flow from the outlet 188 of the auxiliary pump 182 may be delivered to various combinations of the first actuator 102, the second actuator 104, and the third actuator 160 via the conduit 198, the conduit 204, and the conduit 210, respectively. Father depending on the operating mode of the flow control module 184, fluid discharged from any of the first pump 106, the second pump 136, and the third pump 162 may be combined with fluid discharged from another of the first pump 106, the second pump 136, or the third pump 162, respectively via the flow control module 184 to supply fluid power to the first actuator 102, the second actuator 104, the third actuator 160, or combinations thereof. In addition, it will be appreciated that the flow control module 184 may effect less than all of the operating modes outlined in Table 1 without departing from the scope of the disclosure.

The auxiliary pump 182 may have variable displacement, which is controlled via the controller 128 to draw fluid from the reservoir 110 and discharge the fluid at a specified elevated pressure to the conduit 192. The auxiliary pump 182 may include a stroke-adjusting mechanism, for example a swashplate, a position of which is hydro-mechanically adjusted based on, among other things, a desired speed of the actuators, to thereby vary an output (e.g., a discharge rate) of the auxiliary pump 182. It is contemplated that the auxiliary pump 182 may be coupled to the power source 18 in tandem (e.g., via the same shaft) or in parallel (e.g., via a gear train) with other pumps of the machine 10, as desired. Further, the displacement of the auxiliary pump 182 may be adjusted from a zero displacement position at which substantially no fluid is discharged from the auxiliary pump 182, to a maximum displacement position at which fluid is discharged from auxiliary pump 182 at a maximum rate into the conduit 192. According to an aspect of the disclosure, the only connection between the outlet 188 of the auxiliary pump 182 and the hydraulic system 100 is via the conduit 192 and the flow control module 184.

The auxiliary pump 182 may be directly or indirectly coupled to the power source 18 via a shaft 211. Indirect coupling between the shaft 211 of the auxiliary pump 182 and the power source 18 may include a torque converter, a gear box, an electrical circuit, or other coupling method known in the art.

It will be appreciated that the auxiliary pump 182 may also operate as a motor when driven by pressurized fluid supplied to the inlet 232 of the auxiliary pump 182. Thus, the auxiliary pump 182 may convert shaft energy from the shaft 211 into fluid energy at the outlet port 188, or the auxiliary pump 182 may convert fluid energy applied to the inlet 232 into shaft power out through the shaft 211.

As shown in FIG. 3, the hydraulic system 100 may further include an accumulator system 212 including an accumulator 214; however, it will be appreciated that some aspects of the disclosure may not include an accumulator system 212. The accumulator 214 may be fluidly coupled to the first actuator 102 via a conduit 216. According to an aspect of the disclosure the accumulator 214 is fluidly coupled to the head-end chamber 88 of the first actuator 102 via the conduit 216, which is coupled to the conduit 120 at node 218. The accumulator system 212 may further include a check valve 220 and an accumulator charge valve 222, both coupled in series along the conduit 216. The check valve 220 may prevent fluid flow along the conduit 216 in a flow direction from the accumulator 214 toward the first actuator 102, but allow flow along the conduit 216 in a flow direction from the first actuator 102 toward the accumulator 214.

When configured in a first position, the accumulator charge valve 222 may block fluid communication between the accumulator 214 and the head-end chamber 88 of the first actuator 102 via the accumulator charge valve 222. When configured in a second position, the accumulator charge valve 222 may effect fluid communication between the accumulator 214 and the head-end chamber 88 of the first actuator 102 via a valve flow passage 224.

The accumulator charge valve 222 may include a resilient element 226 that biases the configuration of the accumulator charge valve 222 toward the first position. The accumulator charge valve 222 may further include an actuator 228 that acts to bias the configuration of the accumulator charge valve 222 toward the second position, against the resilient element 226. Alternatively, the actuator 228 may be double-acting, and therefore capable of biasing the configuration of the accumulator charge valve toward either its first position or its second position.

The actuator 228 may be a hydraulic actuator, a pneumatic actuator, a solenoid actuator, or any other type of actuator known to persons having skill in the art. The actuator 228 may cause the configuration of the accumulator charge valve 222 to toggle between its first position and its second position. Alternatively, actuator 228 may actuate the configuration of the accumulator charge valve 222 across a spectrum of throttle positions proportional to a control signal applied to the actuator 228. It will be appreciated that the actuator 228 may be operatively coupled to the controller 128 and may be actuated by control signals transmitted therefrom.

The accumulator 214 may also be fluidly coupled to an inlet 232 of the auxiliary pump 182 via a conduit 234 and the conduit 186. The accumulator system 212 may include a check valve 235 arranged such that the accumulator 214 is not in fluid communication with any of the first pump 106, the second pump 136, the third pump 162, or the reservoir 110 via the conduit 234 along a flow direction from the accumulator 214 toward the auxiliary pump 182.

The accumulator system 212 may further include an accumulator discharge valve 236 arranged along and in series with the conduit 234. When configured in a first position, the accumulator discharge valve 236 may block fluid communication between the accumulator 214 and the inlet 232 to the auxiliary pump 182 via the accumulator discharge valve 236. When configured in a second position, the accumulator discharge valve 236 may effect fluid communication between the accumulator 214 and the inlet 232 to the auxiliary pump 182 via a valve flow passage 238.

The accumulator discharge valve 236 may include a resilient element 240 that biases the configuration of the accumulator discharge valve 236 toward the first position. The accumulator discharge valve 236 may further include an actuator 242 that acts to bias the configuration of the accumulator discharge valve 236 toward the second position, against the resilient element 240. Alternatively, the actuator 242 may be double-acting, and therefore capable of biasing the configuration of the accumulator charge valve toward either its first position or its second position.

The actuator 242 may be a hydraulic actuator, a pneumatic actuator, a solenoid actuator, or any other type of actuator known to persons having skill in the art. The actuator 242 may cause the configuration of the accumulator discharge valve 236 to toggle between its first position and its second position. Alternatively, actuator 242 may actuate the configuration of the accumulator discharge valve 236 across a spectrum of throttle positions proportional to a control signal applied to the actuator 242. It will be appreciated that the actuator 242 may be operatively coupled to the controller 128 and may be actuated by control signals transmitted therefrom.

The accumulator 214 may store hydraulic energy as a displacement of a resilient member included therein. The resilient member of the accumulator 214 may include a volume of a gas, a resilient bladder, a coil spring, a leaf spring, combinations thereof, or any other resilient member known in the art.

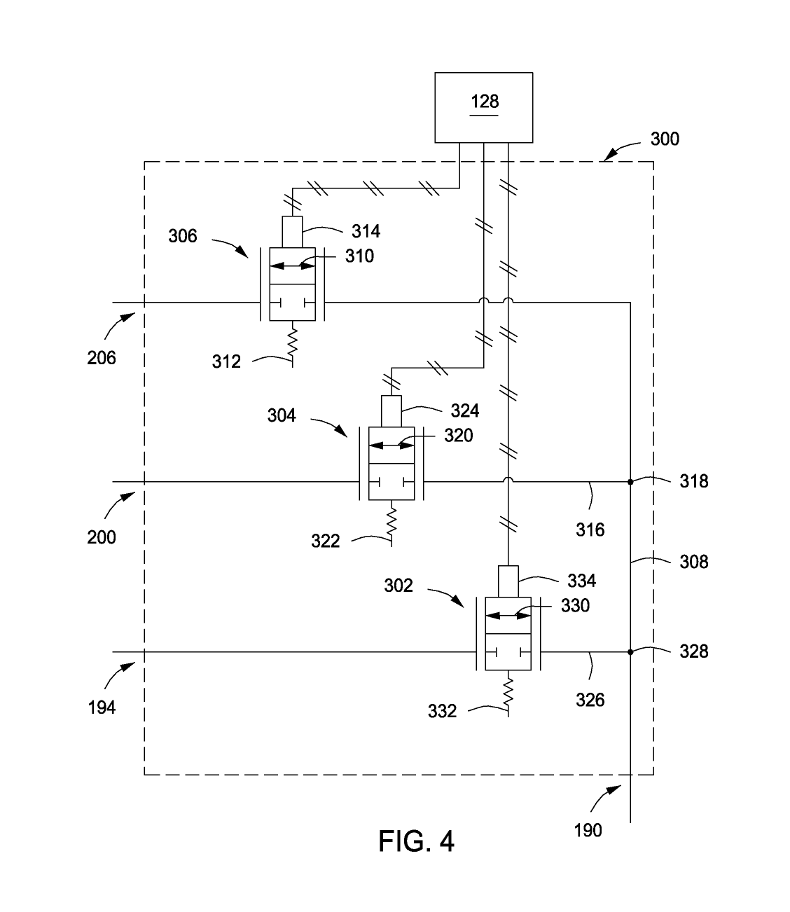

FIG. 4 shows a schematic view of a flow control module 300, according to an aspect of the disclosure. Similar to the flow control module 184 in FIG. 3, the flow control module 300 includes a first port 190, a second port 194, a third port 200, and a fourth port 206. The flow control module 300 further includes a first valve 302, a second valve 304, and a third valve 306.

The third valve 306 is in fluid communication with the first port 190 via a conduit 308 and in fluid communication with the fourth port 206. The third valve 306 has a first position that blocks fluid communication between the fourth port 206 and the first port 190, the second port 194, and the third port 200 via the third valve 306. The third valve 306 also has a second position that may effect fluid communication between the fourth port 206 and the first port 190, the second port 194, the third port 200, or combinations thereof, via a valve passage 310.

The third valve 306 may include a resilient element 312 that biases the third valve 306 toward the first position. Further, the third valve 306 may include an actuator 314 that acts to bias the third valve 306 toward the second position. Alternatively, the actuator 314 may be a double-acting actuator, capable of biasing the third valve 306 toward either the first position or the second position. The actuator 314 may be a hydraulic actuator, a pneumatic actuator, a solenoid actuator, or any other actuator known to persons having skill in the art.

The actuator 314 may be operatively coupled to the controller 128, thereby allowing the controller 128 to actuate the third valve 306 according to a control signal from the controller 128. According to one aspect of the disclosure, the actuator 314 toggles a position of the third valve 306 between the first position and the second position in response to a control signal from the controller 128. According to another aspect of the disclosure, the actuator 314 varies a position of the third valve 306 over a spectrum of throttling positions between the first position and the second position, proportionally to a control signal from the controller 128.

The second valve 304 is in fluid communication with the first port 190 via a conduit 316 that is fluidly coupled to the conduit 308 at a node 318, and the second valve 304 is in fluid communication with the third port 200. The second valve 304 has a first position that blocks fluid communication between the third port 200 and the first port 190, the second port 194, and the fourth port 206 via the second valve 304. The second valve 304 also has a second position that may effect fluid communication between the third port 200 and the first port 190, the second port 194, the fourth port 206, or combinations thereof, via a valve passage 320.

The second valve 304 may include a resilient element 322 that biases the second valve 304 toward the first position. Further, the second valve 304 may include an actuator 324 that acts to bias the second valve 304 toward the second position. Alternatively, the actuator 324 may be a double-acting actuator, capable of biasing the second valve 304 toward either the first position or the second position. The actuator 324 may be a hydraulic actuator, a pneumatic actuator, a solenoid actuator, or any other actuator known to persons having skill in the art.

The actuator 324 may be operatively coupled to the controller 128, thereby allowing the controller 128 to actuate the second valve 304 according to a control signal from the controller 128. According to one aspect of the disclosure, the actuator 324 toggles a position of the second valve 304 between the first position and the second position in response to a control signal from the controller 128. According to another aspect of the disclosure, the actuator 324 varies a position of the second valve 304 over a spectrum of throttling positions between the first position and the second position, proportionally to a control signal from the controller 128.

The first valve 302 is in fluid communication with the first port 190 via a conduit 326 that is fluidly coupled to the conduit 308 at a node 328, and the first valve 302 is in fluid communication with the second port 194. The first valve 302 has a first position that blocks fluid communication between the second port 194 and the first port 190, the third port 200, and the fourth port 206 via the first valve 302. The first valve 302 also has a second position that may effect fluid communication between the second port 194 and the first port 190, the third port 200, the fourth port 206, or combinations thereof, via a valve passage 330.

The first valve 302 may include a resilient element 332 that biases the first valve 302 toward the first position. Further, the first valve 302 may include an actuator 334 that acts to bias the first valve 302 toward the second position. Alternatively, the actuator 334 may be a double-acting actuator, capable of biasing the first valve 302 toward either the first position or the second position. The actuator 334 may be a hydraulic actuator, a pneumatic actuator, a solenoid actuator, or any other actuator known to persons having skill in the art.

The actuator 334 may be operatively coupled to the controller 128, thereby allowing the controller 128 to actuate the first valve 302 according to a control signal from the controller 128. According to one aspect of the disclosure, the actuator 334 toggles a position of the first valve 302 between the first position and the second position in response to a control signal from the controller 128. According to another aspect of the disclosure, the actuator 334 varies a position of the first valve 302 over a spectrum of throttling positions between the first position and the second position, proportionally to a control signal from the controller 128.

As summarized in Table 2, different operating modes of the flow control module 300 effect different states of fluid communication between the first port 190, the second port 194, the third port 200, and the fourth port 206 of the flow control module 300. For example, a first operating mode of the flow control module 300 blocks fluid communication between the first port 190 and any of the second port 194, the third port 200, or the fourth port 206 by closing the first valve 302, the second valve 304, and the third valve 306, whereas a second operating mode of the flow control module 184 effects fluid communication between the first port 190 and the second port 194 by opening the first valve 302 while blocking fluid communication between the first port 190 and either the third port 200 or the fourth port 206 by closing the second valve 304 and the third valve 306.

TABLE 2
Operating Modes for the Flow Control Module 300

| | first valve 302 | second valve 304 | third valve 306 |
|---|---|---|---|
| Mode | position | position | position |
| 1 | closed | closed | closed |
| 2 | open | closed | closed |
| 3 | closed | open | closed |
| 4 | closed | closed | open |
| 5 | open | open | closed |
| 6 | closed | open | open |
| 7 | open | closed | open |
| 8 | open | open | open |

According to an aspect of the disclosure, the fifth operating mode of the flow control module 300 from Table 2 effects fluid communication between second port 194 and the third port 200, as well as effecting fluid communication between the first port 190 and each of the second port 194 and the third port 200 by opening the first valve 302 and the second valve 304. However, it will be appreciated that check valves, or the like, could optionally be added to the flow control module 300, such that the fifth operating mode of the flow control module 300 from Table 1 does not effect fluid communication between the second port 194 and the third port 200.

Similarly, the sixth operating mode of the flow control module 300 may or may not effect fluid communication between the third port 200 and the fourth port 206, and the seventh operating mode of the flow control module 300 may or may not effect fluid communication between the second port 194 and the fourth port 206. Further, an “open” valve configuration, as indicated in FIG. 2, could refer to either a wide open valve position or a partially-throttled, intermediate valve position.

Although FIG. 4 shows a particular structure for the flow control module 300, it will be appreciated that other structures may be applied to achieve the same or similar functions as the flow control module 300 without departing from the scope of the disclosure. Further, it will be appreciated that the flow control module 300 may effect less than all of the operating modes outlined in Table 2 without departing from the scope of the disclosure. The flow control module 184 may be incorporated into a single housing, or the components of the flow control module may be distributed throughout the hydraulic system 100 within multiple housings interconnected by flow passages.

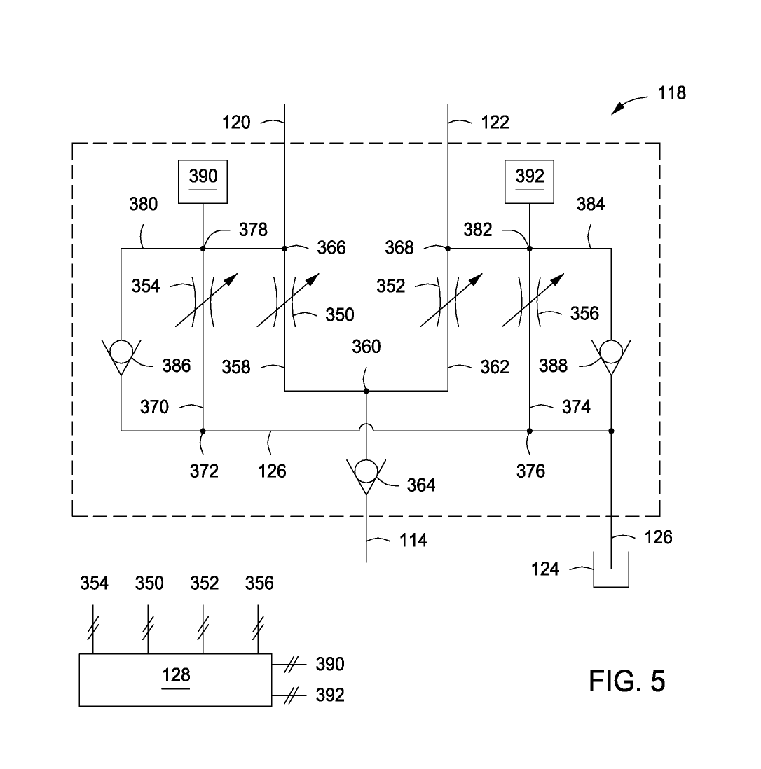

FIG. 5 shows a schematic diagram for the control valve assembly 118, according to an aspect of the disclosure. The control valve assembly 118 may include a first valve 350, a second valve 352, a third valve 354, and a fourth valve 356. The first valve 350 is in fluid communication with the conduit 114 via a conduit 358 at a node 360, and the second valve 352 is in fluid communication with the conduit 114 via a conduit 362 at the node 360. Thus, the first valve 350 and the second valve 352 may be in fluid communication with the first pump 106 (see FIG. 3) via the conduit 114.

The control valve assembly 118 may further include a check valve 364 disposed in series fluid communication with the conduit 114. The check valve 364 may prevent flow through the conduit 114 in a direction away from the node 360, but allow flow through the conduit 114 in a direction toward the node 360.

The first valve 350 is also in fluid communication with the conduit 120 via the node 366, and the second valve 352 is also in fluid communication with the conduit 122 via the node 368. Each of the first valve 350 and the second valve 352 may be actuated according to a control signal from the controller 128 to open or close the valves. Thus, when the first valve 350 is configured in an open position, the first pump 106 (see FIG. 3) may be in fluid communication with the head-end chamber 88 of the first actuator 102 (see FIG. 3) via the conduit 358. Likewise, when the second valve 352 is configured in an open position, the first pump 106 (see FIG. 3) may be in fluid communication with the rod-end chamber 82 of the first actuator 102 (see FIG. 3) via the conduit 362.

Conversely, when the first valve 350 is configured in a closed position, the first pump 106 (see FIG. 3) may be blocked from fluid communication with the head-end chamber 88 of the first actuator 102 (see FIG. 3) via the conduit 358. And when the second valve 352 is configured in a closed position, the first pump 106 (see FIG. 3) may be blocked from fluid communication with the rod-end chamber 82 of the first actuator 102 (see FIG. 3) via the conduit 362. According to an aspect of the disclosure, a valve position or degree of throttling through each of the first valve 350 and the second valve 352 may be proportional to an attribute of the control signal from the controller 128. According to another aspect of the disclosure, a valve position of the first valve 350 or the second valve 352 may toggle between a closed position and a wide open position in response to a change in an attribute of the control signal from the controller 128.

Referring still to FIG. 5, the third valve 354 is in fluid communication with the reservoir 124 via a conduit 370 coupled to the conduit 126 at node 372, and the fourth valve 356 is in fluid communication with the reservoir 124 via a conduit 374 coupled to the conduit 126 at node 376. Further, the third valve 354 is also fluidly coupled to the conduit 120 via node 378 along a conduit 380, and the fourth valve is also fluidly coupled to the conduit 122 via node 382 along a conduit 384.

Thus, when the third valve 354 is configured in an open position, the head-end chamber 88 of the first actuator 102 (see FIG. 3) may be in fluid communication with the reservoir 124 via the conduit 370, and when the fourth valve 356 is configured in an open position, the rod-end chamber 82 of the first actuator 102 (see FIG. 3) may be in fluid communication with the reservoir 124 via the conduit 374. Conversely, when the third valve 354 is configured in a closed position, the head-end chamber 88 of the first actuator 102 (see FIG. 3) may be blocked from fluid communication with the reservoir 124 via the conduit 370, and when the fourth valve 356 is configured in a closed position, the rod-end chamber 82 of the first actuator 102 (see FIG. 3) may be blocked from fluid communication with the reservoir 124 via the conduit 374.

According to an aspect of the disclosure, a valve position or degree of throttling through each of the third valve 354 and the fourth valve 356 may be proportional to an attribute of a control signal from the controller 128. According to another aspect of the disclosure, a valve position of the third valve 354 or the fourth valve 356 may toggle between a closed position and a wide open position in response to a change in an attribute of the control signal from the controller 128.

The control valve assembly 118 may further include a check valve 386 disposed in series fluid communication with the conduit 380 between the node 378 and the node 372. The check valve 386 may prevent flow through the conduit 380 in a direction from the node 378 toward the node 372, but allow flow through the conduit 380 in a direction from the node 372 toward the node 378. The control valve assembly 118 may further include a check valve 388 disposed in series fluid communication with the conduit 384 between the node 382 and the node 376. The check valve 388 may prevent flow through the conduit 384 in a direction from the node 382 toward the node 376, but allow flow through the conduit 384 in a direction from the node 376 toward the node 382. It will be appreciated that the check valve 386 and the check valve 388 may provide makeup flow from the reservoir 124 to a corresponding actuator via the conduit 120 and the conduit 122, respectively, independent of the operating state of the first valve 350, the second valve 352, the third valve 354, or the fourth valve 356.

Referring now to both FIGS. 3 and 5, the first actuator 102 may be actuated in a first direction, against a load, by opening the first valve 350 and the fourth valve 356 while closing the second valve 352 and the third valve 354, thereby delivering pressurized fluid to the head-end chamber 88 of the first actuator 102 and draining fluid from the rod-end chamber 82 of the first actuator 102. Additionally, the first actuator 102 may be actuated in a second direction in an overrun condition, where a load performs work on the first actuator 102, by opening the first valve 350, the second valve 352, and the third valve 354, thereby effecting fluid communication between the head-end chamber 88 and the rod-end chamber 82 via the conduit 120, the conduit 358, the conduit 362, and the conduit 122, and thereby effecting fluid communication between the head-end chamber 88 and the reservoir 124 via the third valve 354 to relieve any fluid discharged by the larger head-end chamber 88 but not accommodated by the smaller rod-end chamber 92. According to an aspect of the disclosure, the first actuator is operated in an overrun condition when the boom 22 of the machine 10 is lowered in the direction of gravity.

The control valve assembly 118 may include a pressure transducer 390 and a pressure transducer 392 in fluid communication with the head-end chamber 88 and the rod-end chamber 82 of the first actuator 102, respectively. Further, the controller 128 may be operatively coupled to the pressure transducer 390 and the pressure transducer 392 and use the pressure signals therefrom to determine whether the first actuator 102 is performing work against a load, operating in an overrun condition, or make other use of the pressure signals known in the art.

Although a particular configuration of the control valve assembly 118 is shown in FIG. 5, it will be appreciated that other structures for the control valve assembly 118 may provide the same or similar functions without departing from the scope of the disclosure. Further, although the control valve assembly 118 in FIG. 5 is exemplified in the context of the first open-loop circuit 108, it will be appreciated that the structure of the control valve assembly 118 may be applied to the control valve assembly 146 in the second open-loop circuit 138 and the control valve assembly 170 in the third open-loop circuit 164.

### INDUSTRIAL APPLICABILITY

The present disclosure may be applicable to any machine including a hydraulic system containing two or more hydraulic actuators. Aspects of the disclosed hydraulic system and method may promote operational flexibility, performance, and energy efficiency of multi-actuator hydraulic systems.

Applicants discovered that a conventional approach of combining the outputs of multiple pumps into a common manifold before distributing the fluid power to individual actuators may result in so-called cross-modulation losses. Cross-modulation losses are incurred when multiple actuators having different pressure demands are supplied by a single fluid source at a single pressure. For example, a manifold may be operated at a high pressure to satisfy the demand of one of several actuators in a hydraulic system at a given point in time. Then, at that same point in time, additional throttling may be required to sustain control over the actuators with lower pressure demands. In turn, the high degree of throttling to supply the low demand actuators may result in higher system power loss than if the individual actuators were supplied by separate fluid sources with more closely tailored supply pressures.

According to an aspect of the disclosure shown in FIG. 3, each of the first actuator 102, the second actuator 104, and the third actuator 160 may have a dedicated corresponding pump, namely the first pump 106, the second pump 136, and the third pump 162, respectively, thereby providing separate fluid sources at potentially different pressures for each actuator. Thus, instead of incurring high throttling losses from a high pressure fluid supply for actuators with low pressure demands at a given point in time, the operation of the dedicated pumps may be manipulated to reduce their corresponding output pressure. Further, as discussed above, the flow control module 184 may selectively allocate fluid power from the auxiliary pump 182 to one or more of the machine 10 hydraulic actuators.

According to an aspect of the disclosure, with reference to FIGS. 1 and 3, the machine 10 is a shovel or an excavator, and the first actuator 102 is a boom hydraulic cylinder 26, the second actuator 104 is a stick hydraulic cylinder 32, the third actuator 160 is a tool hydraulic cylinder 34. According to another aspect of the disclosure the tool 14 is a bucket. During operation of machine 10, shown in FIG. 1, an operator located within station 20 may command a particular motion of the work tool 14 in a desired direction and at a desired velocity by way of the interface device 58.

One or more corresponding signals generated by the interface device 58 may be provided to the controller 128 (see FIG. 3) indicative of the desired motion, along with machine performance information, for example sensor data such as pressure data, position data, speed data, pump or motor displacement data, and other data known in the art. In response to the signals from interface device 58 and based on the machine performance information, controller 128 may generate control signals directed to the a stroke-adjusting mechanism of any of the first pump 106, the second pump 136, the third pump 162, the auxiliary pump 182, or combinations thereof (see FIG. 3) Further, the controller 128 may also generate control signals directed to actuation of any of the control valve assembly 118, the control valve assembly 146, the control valve assembly 170, the accumulator charge valve 222, the accumulator discharge valve 236, or combinations thereof. It will be appreciated that the controller 128 may transmit or receive electronic signals, pneumatic signals, hydraulic signals, wireless electromagnetic signals, mechanical linkage signals, combinations thereof, or any other control signal carrier known in the art.

The controller 128 may further include functionality for estimating the power demand for hydraulic actuators at points in time through a duty cycle. Then based on a comparison of estimated actuator power demand to the rated capacities of the corresponding dedicated pumps, the controller 128 may configure the flow control module 184 to advantageously allocate hydraulic pump outputs to the individual hydraulic actuators to promote system performance and energy efficiency throughout the duty cycle.

A duty cycle of the machine 10 may include a dig function, whereby material may be loaded from a source location into the bucket by a scooping motion of the bucket; a lift and swing function, whereby material is lifted from its source location and translated close to a target location; a dump function, whereby the material is deposited from the bucket to the target location; and a return function, whereby the bucket may be returned to the source location. The dig function, the lift and swing function, the dump function, and the return function may each benefit from simultaneous operation of more than one of the boom hydraulic cylinder 26, the stick hydraulic cylinder 32, and the tool hydraulic cylinder 34 at a given point in time.

Performance of these functions may benefit from transmission of hydraulic power to one of the boom hydraulic cylinder 26, the stick hydraulic cylinder 32, and the tool hydraulic cylinder 34 in excess of the capacity of the actuators' dedicated pump, namely the first pump 106, the second pump 136, and the third pump 162, respectively. Conversely, the power demand for some actuators during a particular function may be less than that actuator's dedicated pump capacity, thereby resulting in unused pump capacity at that time.

For example, during the dig function the power demand for the stick hydraulic cylinder 32 may exceed the rated capacity of its dedicated second pump 136, while the power demand for the boom hydraulic cylinder 26 and the tool hydraulic cylinder 34 may be less than their corresponding dedicated pump's capacity. Similarly, during the lift function the power demand for the boom hydraulic cylinder 26 may exceed the rated capacity of its dedicated first pump 106, while the power demand for the stick hydraulic cylinder 32 and the tool hydraulic cylinder 34 may be less than their corresponding dedicated pump's capacity.

As discussed above, aspects of the disclosure provide a flow control module 184 that is configured to selectively allocate fluid power from an auxiliary pump 182 to supplement the power output of a pump dedicated to a particular hydraulic actuator. Table 3 shows a pump allocation schedule for a digging duty cycle of the hydraulic system 100, according to an aspect of the disclosure.

For example, during the dig function when the stick power demand is high, the controller 128 may cause the flow control module 184 to operate in its third operating mode (see Table 1) to effect fluid communication between the auxiliary pump 182 and the stick hydraulic cylinder 32 via the first port 190 and the third port 200. Further, during the lift function when the boom power demand is high, the controller 128 may cause the flow control module 184 to operate in its second operating mode (see Table 1) to effect fluid communication between the auxiliary pump 182 and the boom hydraulic cylinder 26 via the first port 190 and the second port 194.

TABLE 3
Pump Allocation Schedule for a Digging Duty Cycle

| | Pump Allocation to Actuators by Machine Function | | | |
|---|---|---|---|---|
| | Dig | Lift | Dump | Return |
| Actuator | Function | Function | Function | Function |
| Boom, first | first pump | first pump | first pump | first pump |
| actuator 102 | 106 | 106 + aux. | 106 | 106 |
| | | pump 182 | | |
| Stick, second | second pump | second pum | second pump | second pump |
| actuator 104 | 136 + aux. | 136 | 136 | 136 |
| | pump 182 | | | |
| Bucket, third | third pump | third pump | third pump | third pump |
| actuator 160 | 162 | 162 | 162 + aux. | 162 |
| | | | pump 182 | |

Table 4 shows a pump allocation schedule for a digging duty cycle of the hydraulic system 100, according to another aspect of the disclosure. The pump allocation schedule summarized in Table 4 is similar to that summarized in Table 3, except that during the lift function the controller 128 may cause the flow control module 184 to operate in its fifth mode to effect fluid communication between the auxiliary pump 182 and the second pump 136 with the boom hydraulic cylinder 26 via the first port 190, the second port 194, and the third port 200. Accordingly, the fluid output from the second pump 136 may be shared between the stick hydraulic cylinder 32 and the boom hydraulic cylinder 26 when the flow control module 184 is operated in its fifth mode (see Table 1).

TABLE 4
Pump Allocation Schedule for a Digging Duty Cycle

| | Pump Allocation to Actuators by Machine Function | | | |
|---|---|---|---|---|
| | Dig | Lift | Dump | Return |
| Actuator | Function | Function | Function | Function |
| Boom, first | first pump | first pump | first pump | first pump |
| actuator 102 | 106 | 106 + aux. | 106 | 106 |
| | | pump 182 + | | |
| | | second pump | | |
| | | 136 | | |
| Stick, second | second pump | second pump | second pump | second pump |
| actuator 104 | 136 + aux. | 136 | 136 | 136 |
| | pump 182 | | | |
| Bucket, third | third pump | third pump | third pump | third pump |
| actuator 160 | 162 | 162 | 162 + aux. | 162 |
| | | | pump 182 | |

Referring to FIG. 3, the controller 128 may open the accumulator charge valve 222 when the first actuator 102 is operating in an overrun condition, where a load performs work on the first actuator 102, and thereby permit pressurized fluid from the head-end chamber 88 of the first actuator 102 to flow to the accumulator 214 via the conduit 216. According to an aspect of the disclosure, the first actuator 102 is the boom hydraulic cylinder 26, and an overrun condition may occur when the boom 22 is lowered such that the decrease in potential energy of the weight of the boom and a load supported by the boom performs work on fluid in the head-end chamber 88 of the first actuator 102. As discussed previously, the controller 128 may detect an overrun condition of the first actuator by analysis of pressure signals from the pressure transducer 390 and the pressure transducer 392 (see FIG. 5), or any other means for detecting an overrun condition known in the art.

Further, the controller 128 may selectively open the accumulator discharge valve 236 to apply the fluid energy stored in the accumulator 214 to the inlet 232 of the auxiliary pump 182, thereby effectively increasing the flow, pressure, or both of fluid at the outlet 188 of the auxiliary pump 182 above a level attained with the accumulator discharge valve 236 closed. The opening of the accumulator discharge valve 236 may be conditioned upon a pressure in the accumulator 214 exceeding a threshold pressure, where the controller 128 may assess the pressure in the accumulator 214 via a pressure transducer 394 disposed in fluid communication with the accumulator 214. Further, the opening of the accumulator discharge valve 236 may also be conditioned upon an operating mode of the flow control module 184, a position of an actuator within the hydraulic system 100, pressures sensed from one of the control valve assemblies 118, 146, 170, or any other performance or state variable of the machine 10 known in the art.

Accordingly, aspects of the disclosure enable flexible and efficient allocation of multiple pumps to two or more hydraulic actuators while minimizing or eliminating cross-modulation losses associated with conventional common manifold approaches. Further, the flexibility of pump allocation provided by aspects of the disclosure may enable a reduction in the capacities of the individual pumps in the system, and may enable either downsizing the power source 18 driving the pumps or operating the power source 18 at a lower speed, thereby decreasing fuel consumption for the same amount of work performed by the machine 10. Moreover, the hydraulic system 100 may utilize the accumulator system 212 to advantageously store fluid energy in the accumulator 214 and selectively discharge the stored fluid energy to an actuator via the auxiliary pump 182.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Throughout the disclosure, like reference numbers refer to similar elements herein, unless otherwise specified.

We claim:

1. A hydraulic system, comprising:
a first pump having an outlet that is fluidly coupled to a first actuator via a first conduit;
a second pump having an outlet that is fluidly coupled to a second actuator via a second conduit;
a flow control module fluidly coupled to
an outlet of an auxiliary pump via a third conduit,
the first conduit via a fourth conduit, and
the second conduit via a fifth conduit; and
a controller operatively coupled to the flow control module, the controller being configured to
operate the flow control module in a first mode, such that the flow control module effects fluid communication between the auxiliary pump and the first actuator via the fourth conduit and blocks fluid communication between the auxiliary pump and the second actuator via the fifth conduit, and
operate the flow control module in a second mode, such that the flow control module effects fluid communication between the auxiliary pump and the second actuator via the fifth conduit and blocks fluid communication between the auxiliary pump and the first actuator via the fourth conduit.

2. The hydraulic system according to claim 1, wherein the first mode of the flow control module further effects fluid communication between the second pump and the first actuator via the fifth conduit and the fourth conduit.

3. The hydraulic system according to claim 1, further comprising an accumulator fluidly coupled to the first actuator via a sixth conduit in series with a first valve,
wherein the first valve is operatively coupled to the controller, and
wherein the controller is further configured to selectively effect fluid communication between the first actuator and the accumulator via the first valve.

4. The hydraulic system according to claim 3, wherein
the accumulator and an inlet to the auxiliary pump are fluidly coupled via a seventh conduit in series with a second valve,
the second valve is operatively coupled to the controller, and
the controller is further configured to selectively effect fluid communication between the accumulator and the inlet to the auxiliary pump.

5. The hydraulic system according to claim 1, further comprising a third pump having an outlet that is fluidly coupled to a third actuator via a sixth conduit,
wherein the flow control module is fluidly coupled to the sixth conduit via a seventh conduit, and
wherein the controller is further configured to operate the flow control module in a third operating mode, such that the flow control module effects fluid communication between the auxiliary pump and the third actuator via the seventh conduit and blocks fluid communication between the auxiliary pump and the first actuator via the fourth conduit.

6. The hydraulic system according to claim 3, wherein the controller is further configured to effect fluid communication between the first actuator and the accumulator via the first valve when the first actuator is operating in an overrun condition.

7. A machine comprising the hydraulic system according to claim 1.

8. The machine according to claim 7, wherein the machine is one of a shovel and an excavator.

9. The machine according to claim 8, wherein the first actuator is a linear hydraulic actuator coupled to a boom of the machine.

10. A method of operating a hydraulic system, the hydraulic system including
a first pump having an outlet that is fluidly coupled to a first actuator via a first conduit,
a second pump having an outlet that is fluidly coupled to a second actuator via a second conduit, and
a flow control module fluidly coupled to
an outlet of an auxiliary pump via a third conduit,
the first conduit via a fourth conduit, and
the second conduit via a fifth conduit,
the method comprising:
operating the flow control module in a first mode, such that the flow control module effects fluid communication between the auxiliary pump and the first actuator via the fourth conduit and blocks fluid communication between the auxiliary pump and the second actuator via the fifth conduit; and
operating the flow control module in a second mode, such that the flow control module effects fluid communication between the auxiliary pump and the second actuator via the fifth conduit and blocks fluid communication between the auxiliary pump and the first actuator via the fourth conduit.

11. The method according to claim 10, wherein the operating the flow control module in the first mode further includes effecting fluid communication between the second pump and the first actuator via the fifth conduit and the fourth conduit.

12. The method according to claim 10, further comprising effecting fluid communication between the first actuator and an accumulator via a first valve.

13. The method according to claim 12, further comprising effecting fluid communication between the accumulator and an inlet to the auxiliary pump via a second valve.

14. The method according to claim 13, wherein the effecting fluid communication between the accumulator and the inlet to the auxiliary pump occurs while the flow control module operates in the first mode.

15. The method according to claim 13, wherein the effecting fluid communication between the accumulator and the inlet to the auxiliary pump occurs while the flow control module operates in the second mode.

16. The method according to claim 10, wherein the hydraulic system further includes a third pump having an outlet that is fluidly coupled to a third actuator via a sixth conduit, the flow control module being fluidly coupled to the sixth conduit via a seventh conduit,
the method further comprising operating the flow control module in a third mode, such that the flow control module effects fluid communication between the auxiliary pump and the third actuator via the seventh conduit and blocks fluid communication between the auxiliary pump and the first actuator via the fourth conduit.

17. The method according to claim 10, wherein the operating the flow control module in the first mode is triggered by
comparing a flow demand of the first actuator to a flow capacity of the first pump, and
determining that the flow demand of the first actuator is greater than the flow capacity of the first pump.

18. The method according to claim 11, wherein the operating the flow control module in the third mode is triggered by
comparing a flow demand of the first actuator to a combined flow capacity of the first pump and the auxiliary pump, and
determining that the flow demand of the first actuator is greater than the combined flow capacity of the first pump and the auxiliary pump.

19. The method according to claim 10, wherein the operating the flow control module in the second mode is triggered by
comparing a flow demand of the second actuator to a flow capacity of the second pump, and
determining that the flow demand of the second actuator is greater than the flow capacity of the second pump.

20. The method according to claim 16, wherein the operating the flow control module in the third mode is triggered by
comparing a flow demand of the third actuator to a flow capacity of the third pump, and
determining that the flow demand of the third actuator is greater than the flow capacity of the third pump.
